(19) United States
(12) Patent Application Publication
(10) Pub. No.: US 2018/0330356 A1
(43) Pub. Date: Nov. 15, 2018

(54) TRANSMISSION, VIA A VIRTUAL PERSONA, LEVERAGING FRAUD DETECTION NETWORKS

(71) Applicant: Bank of America Corporation, Charlotte, NC (US)

(72) Inventors: Tony England, Tega Cay, SC (US); Pavan K. Chayanam, Danville, CA (US); Hari Gopalkrishnan, Plainsboro, NJ (US)

(21) Appl. No.: 15/594,836

(22) Filed: May 15, 2017

(51) Int. Cl. G06Q 20/32; G06F 21/36; G06F 17/30; H04L 12/58

(52) U.S. Cl. CPC G06Q 20/3224; G06Q 20/3276; H04L 51/24; G06Q 20/3221; G06F 17/30719; G06F 21/36

(57) ABSTRACT

An apparatus for electronic transmission via a virtual persona is provided. The apparatus may include a receiver. The receiver may be located at a first entity's mobile device. The receiver may be configured to receive a request to transmit an electronic transmission. The apparatus may include a processor. The processor may be located at the first entity's mobile device. The processor may be configured to identify a plurality of visible virtual personas. The plurality of visible virtual personas may be associated with a plurality of other mobile devices. Each of the plurality of virtual personas may be associated with a displayable image and/or characteristic set. The identification may be based on information received from a third party fraud detection network. The information may include location information associated with the plurality of other devices. The location information may be currently exploited by the third party fraud detection network.

### FIELD OF TECHNOLOGY

This invention relates to transmitting information via virtual personas. Specifically, this invention relates to virtual persona electronic transmissions that leverage third party networks.

### BACKGROUND OF THE DISCLOSURE

Conventionally, electronic peer-to-peer mobile transmissions are sent from entity to entity, or from person to person over a network. The peer-to-peer electronic transmission typically includes complete identification information regarding the transmitter and the receiver. Because peer-to-peer electronic transmissions include identifying information, networks recommend limiting peer-to-peer electronic transmissions to transmissions between friends, relatives and trusted acquaintances.

It would be desirable to create electronic peer-to-peer mobile transmissions that utilize virtual personas in order to minimize identifying information included in transmissions between the transmitter and the receiver.

### SUMMARY OF THE DISCLOSURE

Apparatus and methods for electronic transmission via a virtual persona are provided. The method may include receiving a request to transmit an electronic transmission. The receiving may occur at a first entity's mobile device. The method may include identifying a plurality of visible virtual personas associated with a plurality of other mobile devices. The identifying may occur at the first entity's mobile device. Each of the virtual personas may be associated with a displayable image, video chip and/or characteristic set.

The identifying may be based on information received from a third party fraud detection network. The information may include location information. The location information may be associated with the plurality of other devices. The location information may be currently exploited by the third party fraud detection network. The third party fraud detection network may include a plurality of associations. Each association may be between a payment instrument and one of the plurality of other devices. The location information may be identified each time the payment instrument operates as a payment method. The payment method may be for a transaction. The transaction may be validated when the terminal in which the payment instrument is being used is within a predetermined distance to the mobile device associated with the payment instrument. The location information may be identified using global positioning system (“GPS”) locators included in each mobile device.

The plurality of other mobile devices may be located within a specific radial, location-based, perimeter constraint. The radial, location-based, perimeter constraint may be defined with respect to the location of the first entity's mobile device. In some embodiments, the radial, location-based, perimeter constraint may be dynamic. The size of the perimeter may be based on the amount of virtual personas detected in the area around the first entity's mobile device. For example, in a more heavily populated area, such as a crowded office lobby, the radial, location-based, perimeter constraint may be relatively smaller than a typical constraint size. Because over a threshold level of virtual personas are identified within a smaller radius, a smaller constraint size may be used. In a less populated area, such as a room in a residential home, the radial, location-based, perimeter constraint may be relatively larger than a typical constraint size. Because less than a threshold level of virtual personas are identified within a typical radius, a larger constraint size may be used.

It should be appreciated that the radial, location-based, perimeter constraint may be along an x-axis as well as along a y-axis. The y-axis element of the constraint may be especially useful when identifying virtual personas on more than one floor of a building.

The method may include displaying one or more of the plurality of visible virtual personas, associated with the plurality of other mobile devices, on the first entity's mobile device. The method may also include displaying one or more virtual personas associated with the first entity's mobile device. Each of the one or more virtual personas may include a displayable image and/or character set. The displayable image and/or character set may identify a specific feature or quality associated with the first entity. For example, a virtual persona may include the name “Marriot Downtown NY occupant A.” A characteristic set associated with the name “Marriot Downtown NY occupant A” may include the room of the hotel which the occupant occupied. The receiver of the electronic transmission may understand that the transmission was received from a first entity's mobile device that includes the persona—“Marriot Downtown NY occupant A.”

The method may include receiving a first selection from the first entity. The first selection may include a virtual persona associated with the first entity. The virtual persona may be displayed on the first entity's mobile device.

The method may include receiving a second selection from the first entity. The second selection may include a visible virtual persona displayed on the first entity's mobile device. The virtual persona may be displayed on the first entity's mobile device. The visible virtual persona may be associated with a second mobile device. The second mobile device may be included in the plurality of other mobile devices. The second mobile device may be located within the location-based perimeter constraint.

The method may include transmitting the electronic transmission. The transmission may be transmitted over a transmission network. The transmission may be transmitted to a storage location associated with the second selected virtual persona. The transmission may be transmitted to a storage location associated with the transmission network. The transmission may be transmitted to any other suitable storage location.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram according to certain embodiments;

FIG. 2 shows another illustrative diagram according to certain embodiments;

FIG. 3 shows still another illustrative diagram according to certain embodiments;

FIG. 4 shows yet another illustrative diagram according to certain embodiments;

FIG. 5 shows still another illustrative diagram according to certain embodiments;

FIG. 6 shows yet another illustrative diagram according to certain embodiments;

FIG. 7 shows still another illustrative diagram according to certain embodiments;

FIG. 8 shows yet another illustrative diagram according to certain embodiments;

FIG. 9 shows still another illustrative diagram according to certain embodiments;

FIG. 10 shows yet another illustrative diagram according to certain embodiments;

FIG. 11 shows still another illustrative diagram according to certain embodiments;

FIG. 12 shows yet another illustrative diagram according to certain embodiments;

FIG. 13 shows still another illustrative diagram according to certain embodiments;

FIG. 14 shows yet another illustrative diagram according to certain embodiments;

FIG. 15 shows still another illustrative diagram according to certain embodiments;

FIG. 16 shows yet another illustrative diagram according to certain embodiments;

FIG. 17 shows still another illustrative diagram according to certain embodiments;

FIG. 18 shows yet another illustrative diagram according to certain embodiments;

FIG. 19 shows still another illustrative diagram according to certain embodiments;

FIG. 20 shows yet another illustrative diagram according to certain embodiments; and

FIG. 21 shows an illustrative flow chart according to certain embodiments.

### DETAILED DESCRIPTION OF THE DISCLOSURE

Apparatus and methods for electronic transmission via a virtual persona is provided. The apparatus may include a receiver. The receiver may be configured to receive a request to transmit an electronic transmission. The request may be located in the first entity's mobile device.

The apparatus may include a processor. The processor may be configured to identify a plurality of visible virtual personas with a plurality of other mobile devices. The processor may be located at the first entity's mobile device. Each of the virtual personas may be associated with a displayable image. Each of the virtual personas may be associated with a character set.

The identification may be based on information received from a third party fraud detection network. The information may include location information. The location information may be associated with the plurality of other devices. The location information may be currently exploited by the third party fraud detection network.

The third party fraud detection network may include a plurality of associations. Each association may be between a payment instrument and one of the plurality of other devices. The location information may be identified each time the payment instrument operates as a payment method. The location information may be identified using GPS locators included in each mobile device.

The third party fraud detection network may check or verify the geographic location of a mobile device. The verification may occur each time a transaction attempt is made from a payment instrument associated with the mobile device. The transaction may be validated when the mobile device is determined to be located within a predetermined distance from the associated payment instrument. The transaction may be invalidated when the mobile device is determined to be located outside a predetermined distance from the associated payment instrument.

The use of the third party fraud detection network according to certain embodiments may co-opt the bandwidth of the third party fraud detection network to identify the location and identify the plurality of visible virtual personas.

The identification of the plurality of visible virtual personas may occur on a predetermined schedule. For example, the identification may occur at 9:00 AM, 12:00 PM and 3:00 PM on Mondays-Fridays and at 1:00 PM and 6:00 PM on Saturdays and Sundays. The identification of the plurality of visible virtual personas may occur upon completion of a predetermined interval of time. For example, the identification may occur every 15 minutes. The identification may involve the one or more communications between the mobile device and the third party network.

The plurality of other devices may be located within a specific radial, location-based, perimeter constraint. The perimeter constraint may be defined by a radial distance from the first entity's mobile devices. The perimeter constraint may be regular or irregular. The radial, location-based, perimeter constraint may be defined with respect to the first entity's mobile device.

The apparatus may include a display. The display may be located at the first entity's mobile device. The display may be configured to display the visible virtual personas on the first entity's mobile device.

The apparatus may include the receiver. The receiver may be configured to receive a selection of a visible virtual persona. The selection may occur on the first entity's mobile device. The visible virtual persona may be associated with a second mobile device. The second mobile device may be included in the plurality of other mobile devices. The second mobile device may be located within the location-based perimeter constraint.

The apparatus may include a transmitter. The transmitter may be configured to transmit the electronic transmission. The transmission may be over, or via, a transmission network. The transmitter may transmit the transmission to a storage location. The storage location may be associated with the second selected virtual persona. The transmitter may transmit the transmission to a second storage location. The second storage location may be associated with the transmission network.

A method for electronic transmission via a virtual persona is provided. The method may include receiving a request to transmit an electronic transmission. The receiving may occur at a first entity's mobile device.

The method may include photographing a quick response (“QR”) code. The photographing may occur at the first entity's mobile device. The QR code may be associated with a virtual persona. The virtual persona may be associated with a second entity's mobile device. The virtual persona may be associated with a displayable image and/or character set.

The method may include identifying the virtual persona associated with the QR code. The identifying may include transmitting, or uploading, the QR code to a website. The identifying may include receiving, or downloading, the virtual persona in response to transmitting the QR code.

The method may include displaying the virtual persona on the first entity's mobile device. The method may include receiving a first selection of a virtual persona from the first entity. The virtual persona included in the first selection may be associated with the first entity. The virtual persona associated with the first entity may be selected from a plurality of virtual personas associated with the first entity. The virtual persona associated with the first entity may include a displayable image associated with the first entity. The virtual persona associated with the first entity may include an alphanumeric character set associated with the first entity.

The method may include receiving a second selection of a virtual persona from the first entity. The virtual persona included in the second selection may be the identified virtual persona. The second entity may receive an alert when the transmission is received at a storage location associated with the second entity's mobile device. The alert may relate to the electronic transmission. The alert may include details of the transmission.

The method may include transmitting the electronic transmission. The transmitting may be done via, or over, a transmission network. The transmission may be transmitted to one or more storage locations. The one or more storage locations may be associated with the second entity's mobile device. The one or more storage locations may be associated with transmission network.

The steps of methods recited herein may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

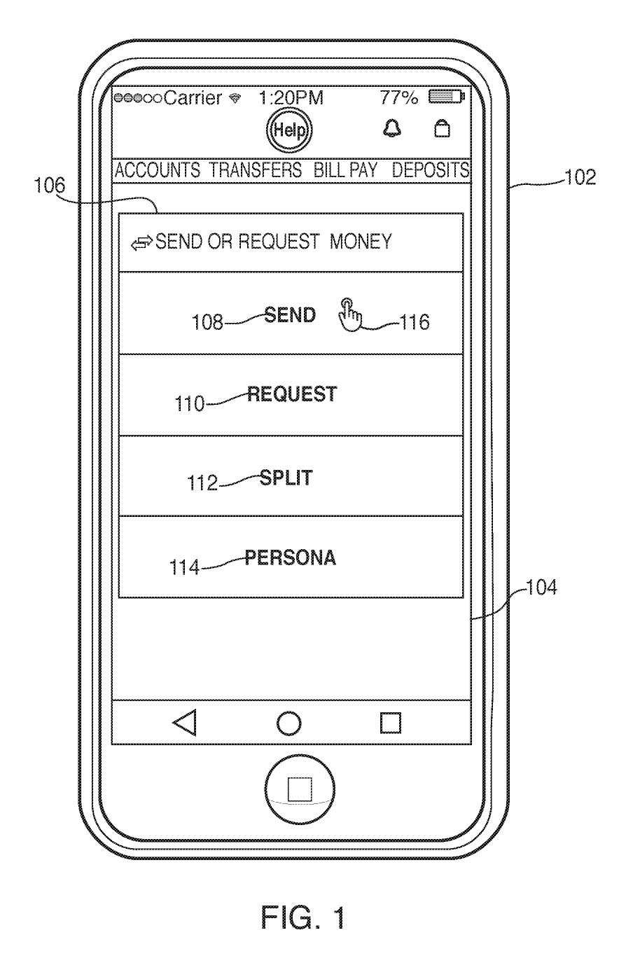

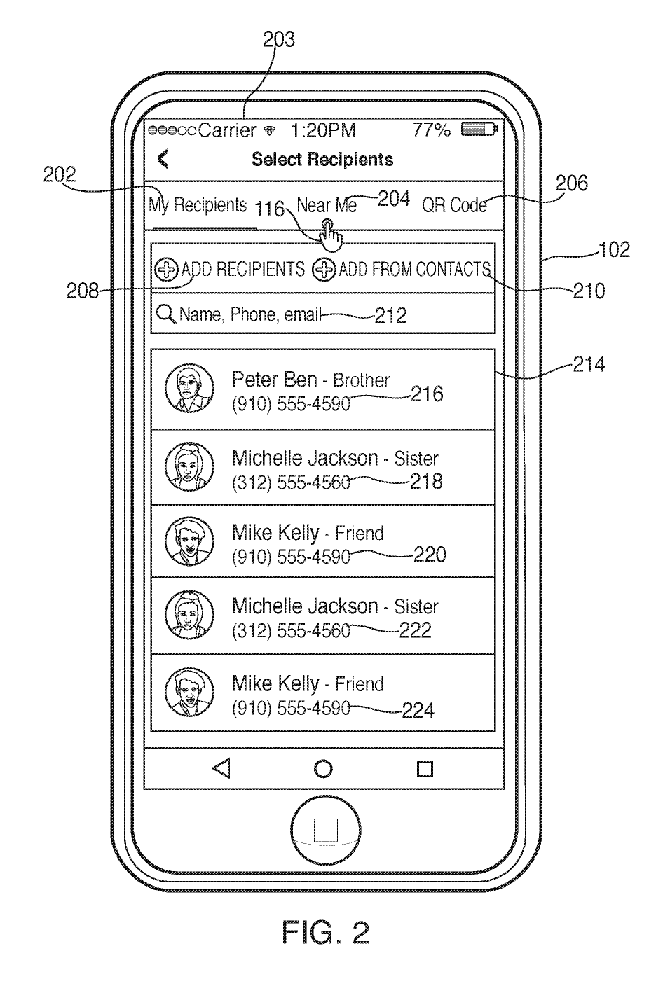

FIG. 1 shows application screen 104 open on mobile device 102. A user of mobile device 102 may send or request money, as shown at 106. There may be a plurality of options to send or request money. The plurality of options may include send button 108, request button 110, split button 112 and persona button 114. Cursor 116 situated on send button 108 may show that the user of mobile device 102 may select send button 108. Selection of send button 108 may direct the user to application screen 203, shown in FIG. 2.

FIG. 2 shows application screen 203 open on mobile device 102. Application screen 203 may be open to my recipients 202, indicated by the line underneath the wording “my recipients.” The user may add recipients, as shown at add recipients button 208. The user may add recipients from contacts, as shown at add from contacts button 210. A user may search for recipients by typing identifying information, such as name, phone number or email address information into entry field 212. Mobile device 102 may retrieve complete recipient information by comparing the entered information to stored information, such as internet sites, or storage information on the mobile device.

A list of recipients may be shown at 214. The list may include an individual, as well as identifying information regarding the individual. The identifying information may include association information, a photograph, a playable video clip and/or phone number information. The list may be structured in order of most recent transaction. Therefore, an individual may show up more than once on the list in the event that the individual was involved in more than one transaction as a recipient. List 203 may include individuals Peter Ben, shown at 216, Michelle Jackson, shown at 218 and Mike Kelly, shown at 220. Both Michelle Jackson and Mike Kelly may have been recipients of additional transactions, shown at 222 and 224 respectively.

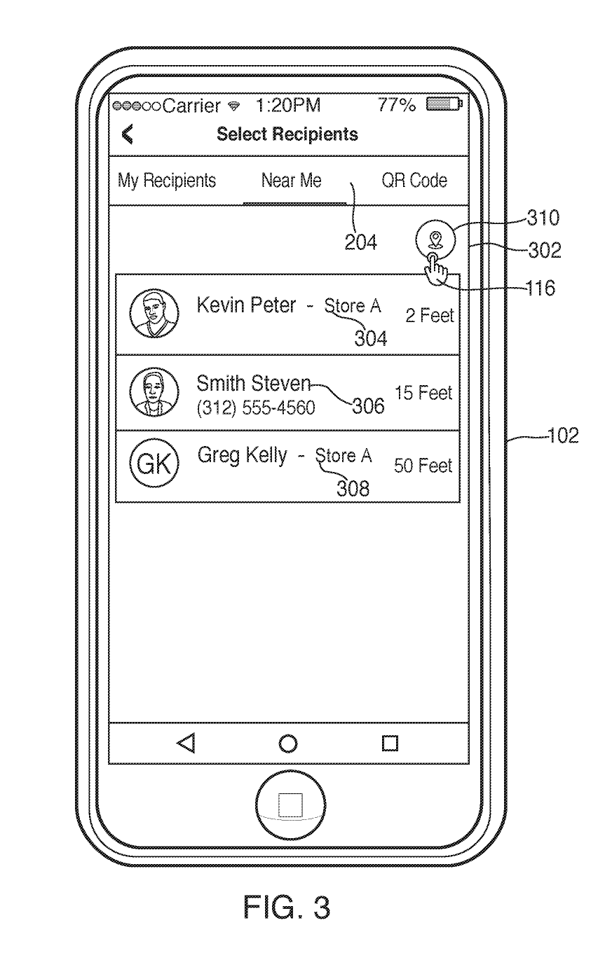

The user may select recipients using a QR code, as shown at 206. The user may select recipients near me, or geographic based, as shown at 204. Cursor 116 may show selecting recipients near me. Selecting recipients near me may direct the user to application screen 302 shown in FIG. 3.

FIG. 3 shows application screen 302 open on mobile device 102. Application screen 302 may be open to near me 204, as indicated by the line underneath the wording “near me.” Application Screen may display a list of possible recipients, or virtual personas, near mobile device 102. It should be appreciated that the individuals shown may have been required to make their personas visible in order for mobile device 102 to detect the personas. It should also be appreciated that the visible virtual personas may not include a considerable amount of identifying information about the person associated with the virtual persona. For example, the persona shown at 304, may include a photo of the person associated with the persona, a first name associated with the persona (Kevin), the entity with which the persona is currently associated (Store A) and the distance from mobile device 102 to persona 304 (two feet).

Persona 306 may include a different set of identifying information than persona 304. Persona 306 may include a photograph, first name, a last name, a phone number and distance information. Persona 308 may include a different set of identifying information than personas 304 and 306. The identifying information may include a first name, a last name, an entity with which the persona is currently associated (Store A) and distance information.

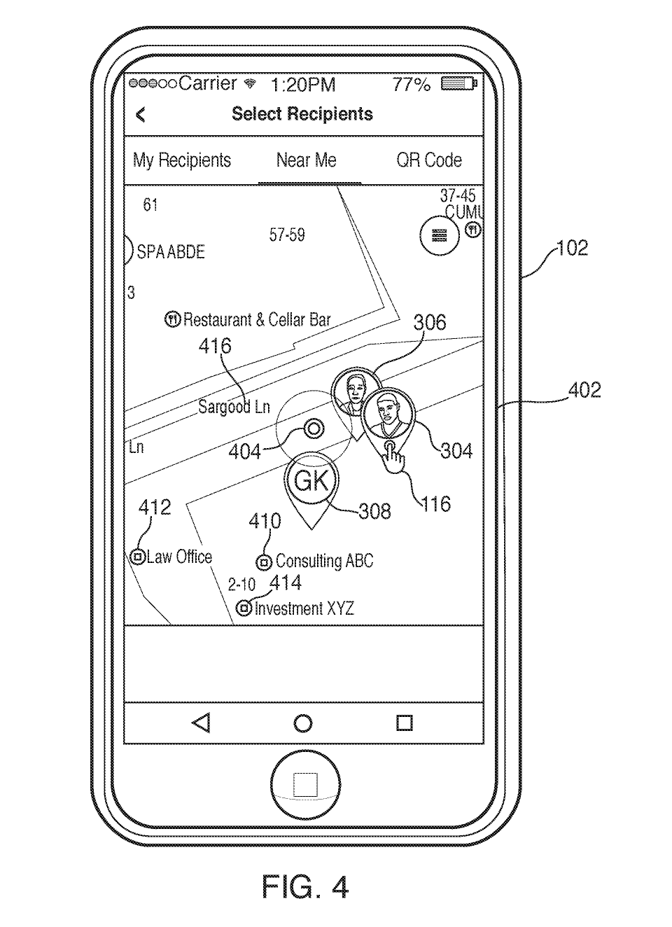

Icon 310 may be a map button. When selected, icon 310 may direct the user to a map display showing persona locations. Cursor 116 may select icon 310. The user may be directed to FIG. 4.

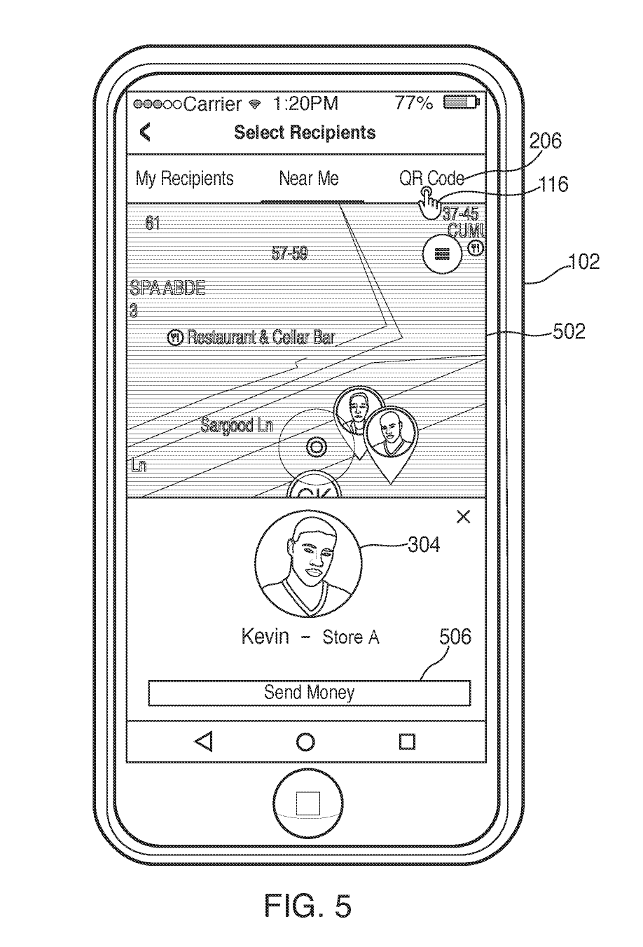

FIG. 4 shows application screen 402 open on mobile device 102. A map may show visible personas in the vicinity of mobile device 102. Icon 404 shows the current geographic location of mobile device 102. A photograph or identifying information of each persona, shown on application screen 302, is included in a location bubble on application screen 402. Personas 304, 306 and 308 are shown on application screen 403. Other information may include business in the area, such as Consulting ABC 410, Law office 412 and Investment XYZ 414 are also shown. Other information may also include street names, such as Sargood Ln 416. Cursor 116 may be placed on persona 304. Selecting persona 304 may direct the user to screen 502, shown in FIG. 5.

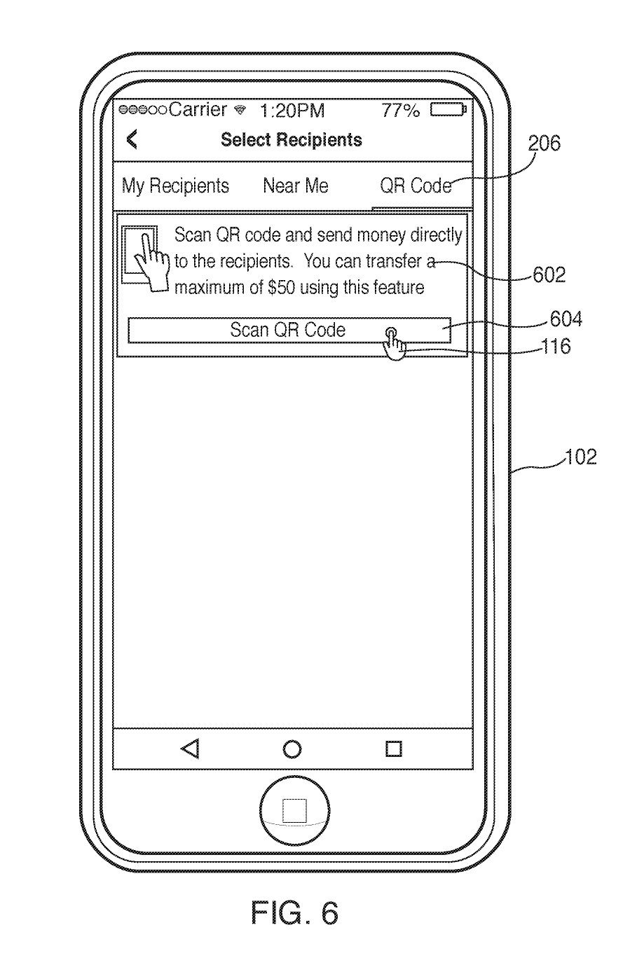

FIG. 5 shows application screen 502 open on mobile device 102. Application screen 502 may show persona details of persona 304. The map shown in FIG. 4 may be grayed out to indicate that the user has already made a persona selection. A user may select button 506 to send money to persona 304 (Kevin from Store A). Cursor 116 may be placed on QR code button 206. Selecting QR code button 206 may direct the user to screen 602 on FIG. 6.

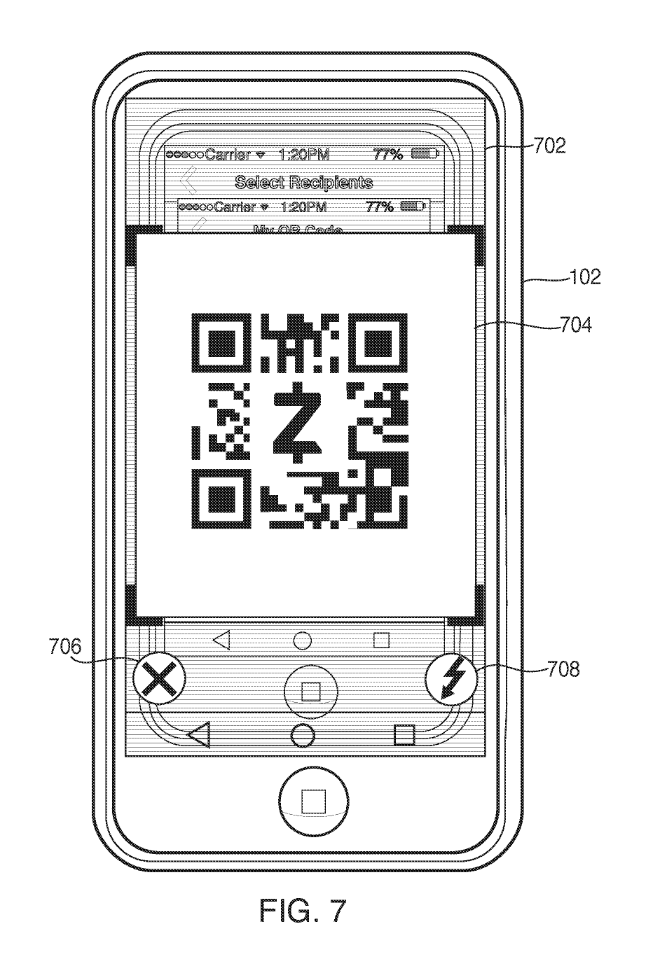

FIG. 6 shows application screen 602 open on mobile device 102. The line underneath “QR code” 206 indicates that application screen 602 is open to QR code information. Application screen 602 includes instruction to scan a QR code in order to send money to recipients. This method may enable a user to transfer electronic transmissions to recipients in the event the recipient is not in the vicinity of mobile device 102 or in the event that the visibility of the recipient's mobile device is turned off. Cursor 116 may be situated on scan QR code button 604. Selecting scan QR code button 604 may direct a user to application screen 702 of FIG. 7.

FIG. 7 shows application screen 702 located on mobile device 102. Application screen 702 includes a grayed-out screen with image 704. A user may accept image 704 without selecting any options. A user may reject image 704 using button 706. A user may use a photographic flash by selecting button 708.

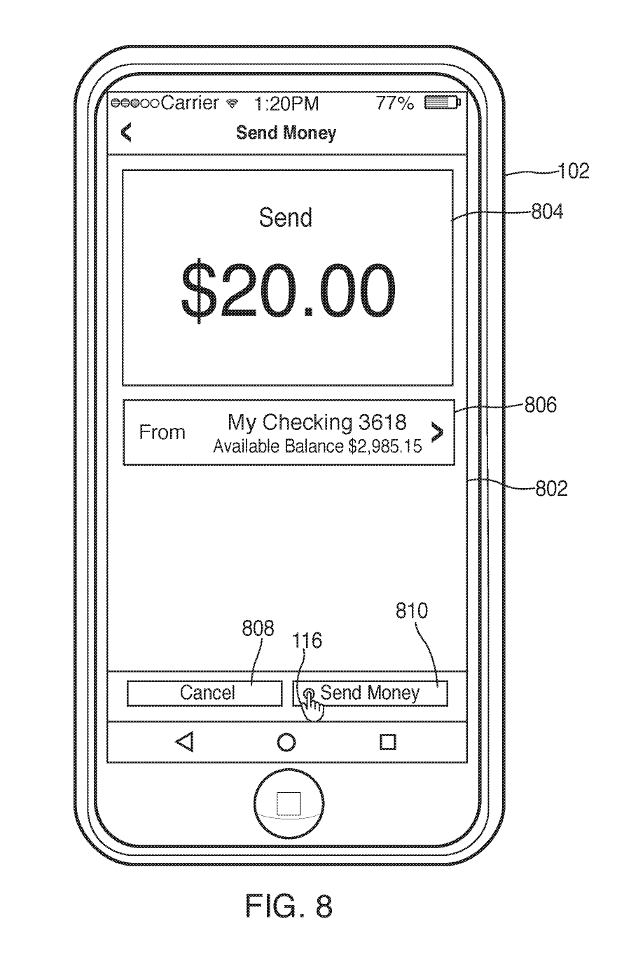

FIG. 8 shows application screen 802 open on mobile device 102. A user may be directed to application screen 802 from application screens 702 and/or 502.

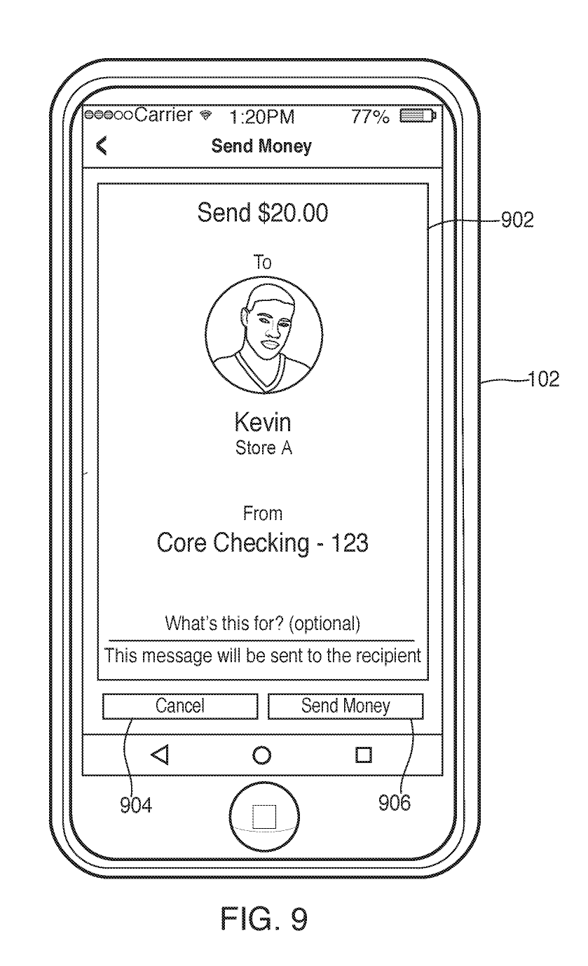

Section 804 allows the user to input the amount of the electronic transmission. An exemplary amount for a transmission may be twenty dollars. Section 806 allows the user to input the account from which the electronic transmission is withdrawn. An exemplary account for a transmission may be my checking account ending in 3618. Section 806 may also inform the user of the available balance in the checking account. Cancel button 808 allows the user to cancel the transmission. Send money 810 allows the user to move to the next step of the transmission. Cursor 116 may select button 810. The user may be directed to application screen 902 of FIG. 9.

FIG. 9 shows application screen 902 displayed on mobile device 102. Application screen 902 may provide a summary of the electronic transmission. The summary may include the monetary amount, the recipient's virtual persona and the identity of the account from which the money was withdrawn. Cancel button 904 may enable a user to cancel the transmission. Send money button 906 may enable the user to complete the transmission.

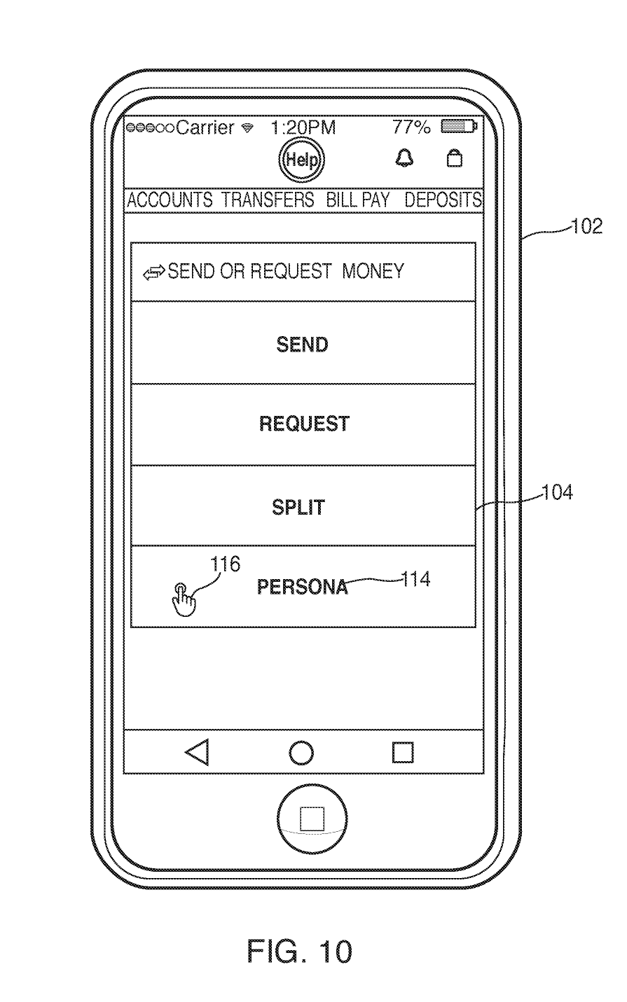

FIG. 10 shows application screen 104 open on mobile device 102. Cursor 116 may be positioned on persona button 114. Selecting persona button 114 may direct a user to application screen 1102 of mobile device 102.

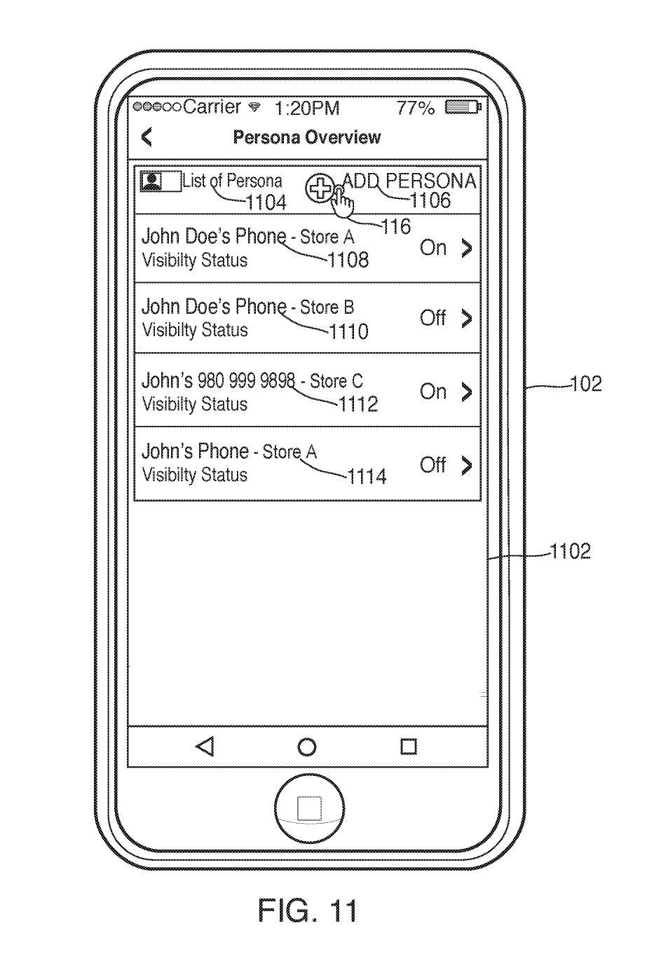

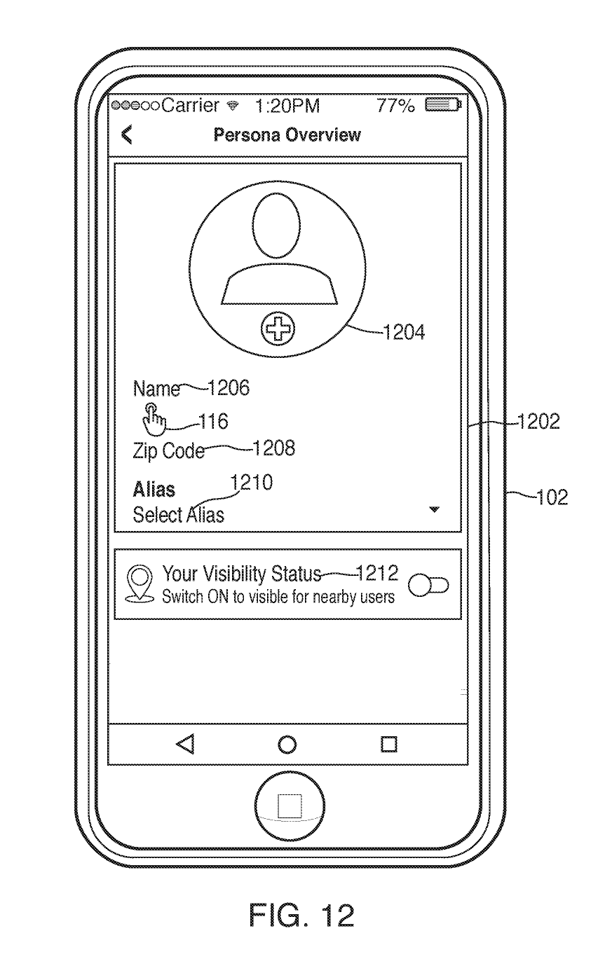

FIG. 11 shows application screen 1102 open on mobile device 102. Application screen 1102 may include a list of personas associated with mobile device 102, as shown at 1104. The list of personas may include John Doe's Phone at Store A, as shown at 1108. The visibility status of persona 1108 may be turned on. The list of personas may include John Doe's Phone at Store B, as shown at 1110. The visibility status of persona 1110 may be turned off. The list of personas may include John's 980 999 9898—Store C, as shown at 1112. The visibility status of persona 1112 may be turned on. The list of personas may include John's phone at Store A, as shown at 1114. The visibility status of John's phone at Store A may be turned off. Cursor 116 may be positioned on add persona button 1106. Selecting add persona button 1106 may direct the user to application screen 1202 shown on FIG. 12.

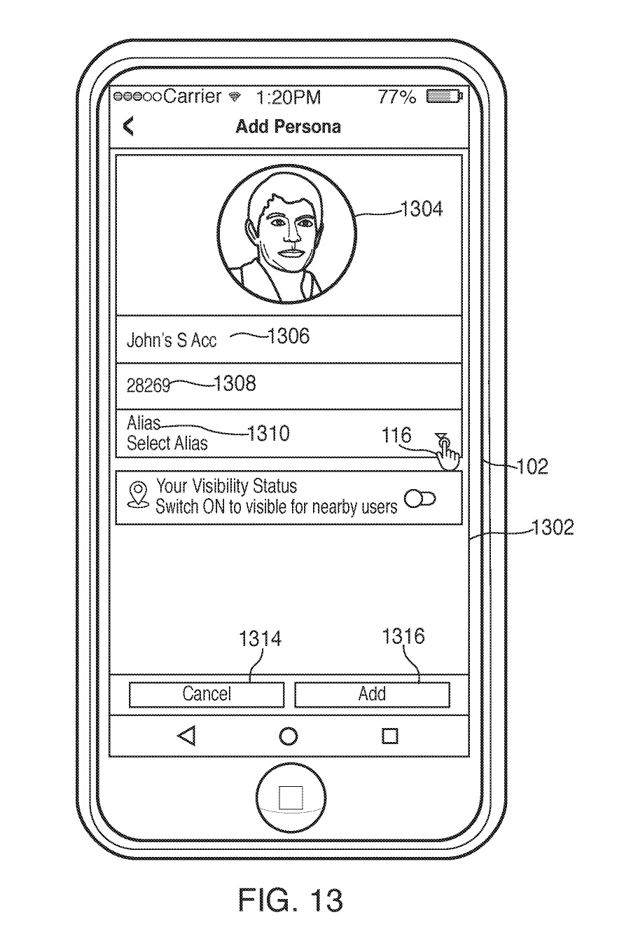

FIG. 12 shows application screen 1202 open on mobile device 102. The user associated with mobile device 102 may create a persona to be saved on the mobile device. The persona may include an image, as shown at 1204. The persona may include a name, as shown at 1206. The persona may include a zip code, as shown at 1208. The persona may include alias, as shown at 1210. A user may switch the visibility status of the persona on or off, as shown at 1212. Cursor 116 may be positioned on name button 1206. A user may be directed to screen 1302 on FIG. 13 upon selecting name button 1206.

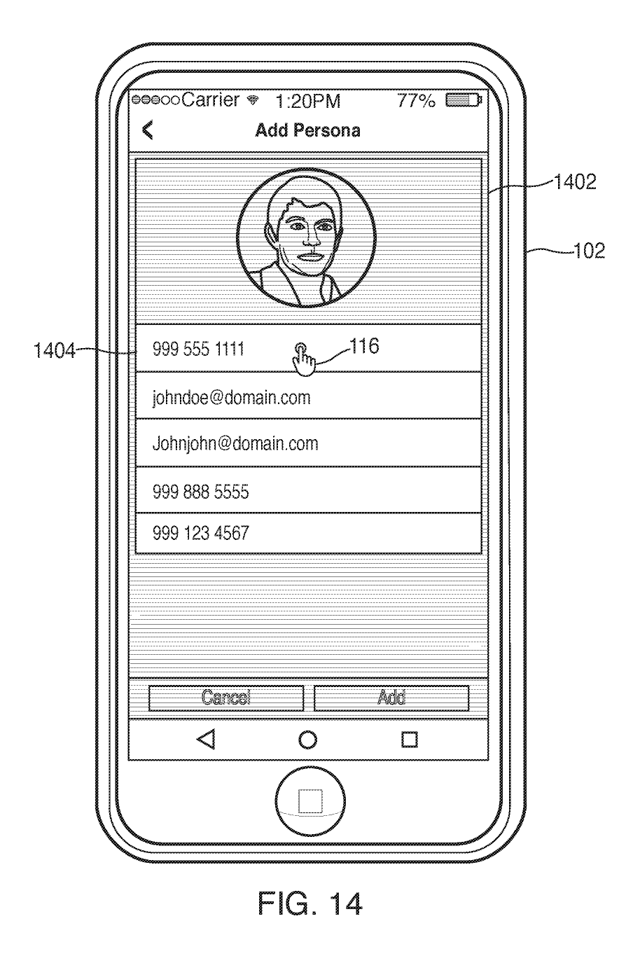

FIG. 13 shows application screen 1302 open on mobile device 102. An image may have been added to the persona, as shown at 1304. A persona name may have been added to the persona, as shown at 1306. A zip code may have been added to the persona, as shown at 1308. The user may add the persona using add button 1316. The user may cancel the persona using cancel button 1314. Cursor 116 may be positioned on alias button 1310. Selecting alias button 1310 may direct the user to screen 1402 on FIG. 14.

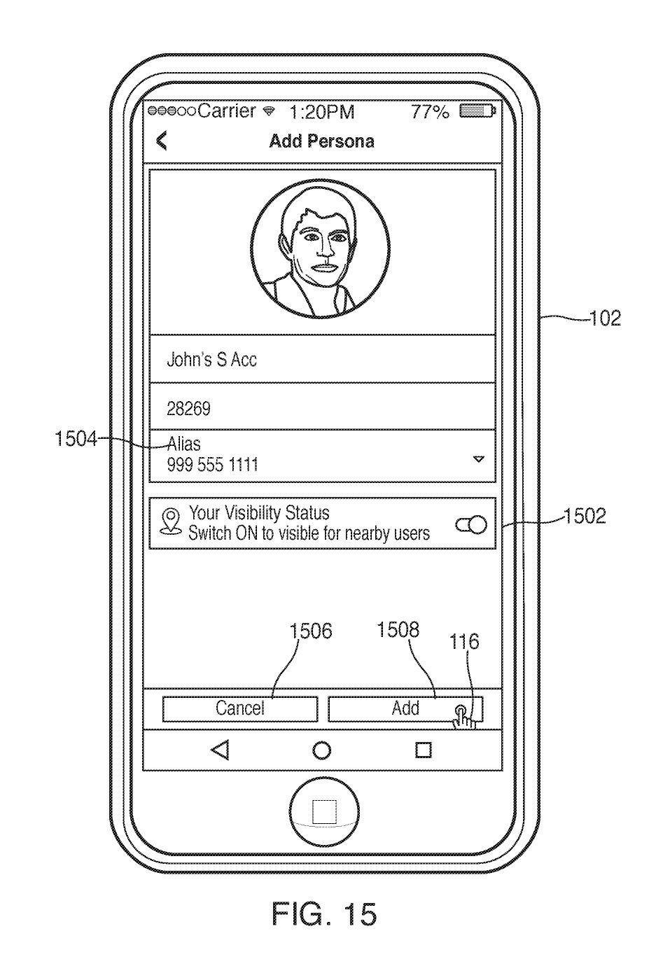

FIG. 14 shows application screen 1402 open on mobile device 102. Application screen 1402 may include list 1404 on top of grayed-out application screen 1302. List 1404 may include a plurality of aliases. The aliases may include phone numbers and/or emails addresses of the user of mobile device 102. Cursor 116 may be positioned on phone number: 999-555-1111. Upon selection of the phone number, the user may be directed to screen 1502 on FIG. 15.

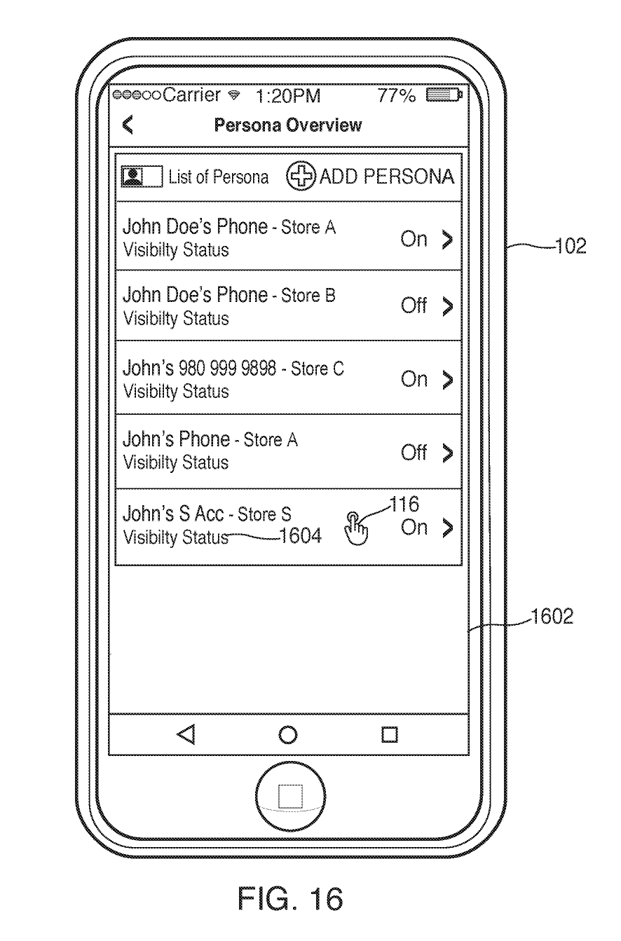

FIG. 15 shows application screen 1502 open on mobile device 102. Application screen 1502 may include the name of the persona, a zip code and an alias. The alias may be the selected alias, as shown at 1504. The user may cancel the persona by clicking cancel button 1506. Cursor 116 may be positioned on add button 116. Selecting add button 116 may direct the user to screen 1602 of FIG. 16.

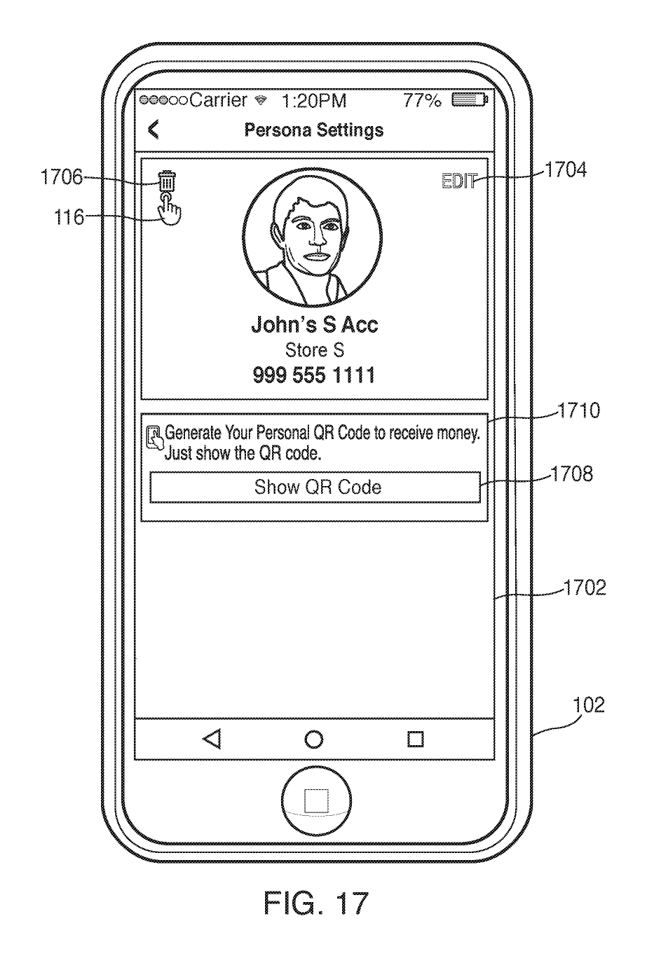

FIG. 16 shows application screen 1602 open on mobile device 102. Application screen 1602 may include a list of personas. It should be appreciated that John's S Account has been added to the list of personas, as shown at 1604. Cursor 116 is positioned on John's S Account. When selected, John's S Account will direct the user to application screen 1702 of FIG. 17.

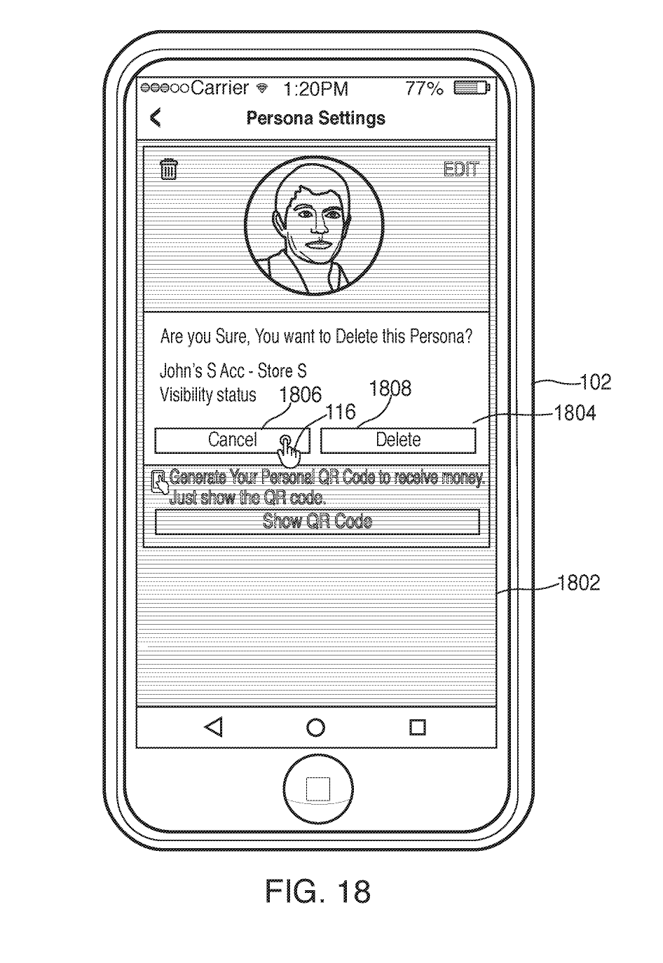

FIG. 17 shows application screen 1702 open on mobile device 102. Application screen 1702 may display a summary of John's S Account persona. The user may edit the persona by selecting edit button 1704. A user may delete the persona by selecting delete button 1706. A user may generate a QR code for another mobile device to photograph, using show QR code button 1708 included in section 1710. Cursor 116 may be positioned on delete button 1706. Selecting delete button 1706 may direct the user to application screen 1802 on FIG. 18.

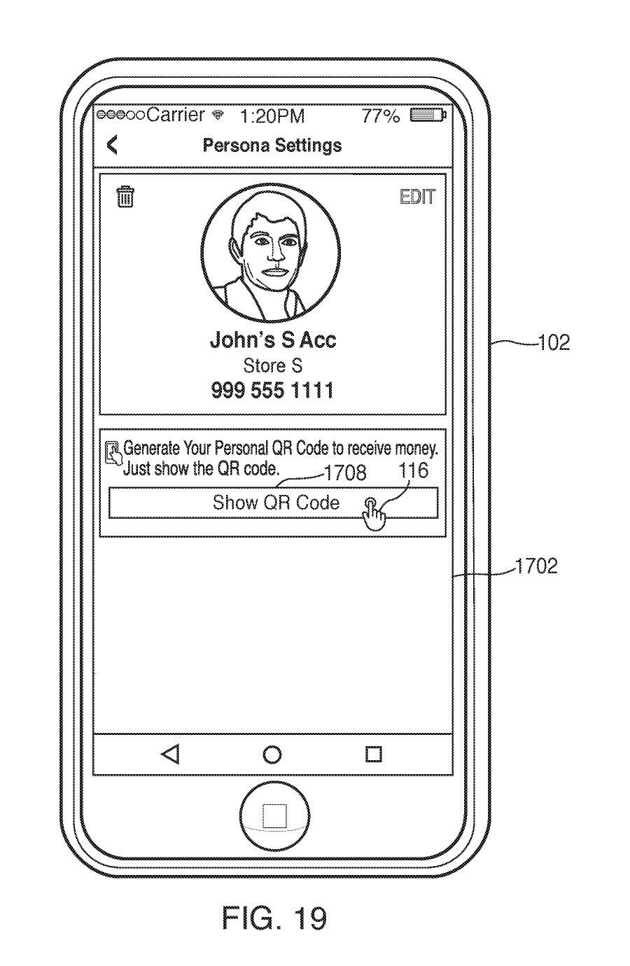

FIG. 18 shows application screen 1802 open on mobile device 102. Section 1804 may appear on top of grayed-out application screen 1702. Section 1804 may enable the user to delete the persona using delete button 1808. A user may cancel the deletion by selection cancel button 1806. Cursor 116 may be positioned on cancel button 1806. Cancel button 1806 may direct the user to application screen 1702 of FIG. 19.

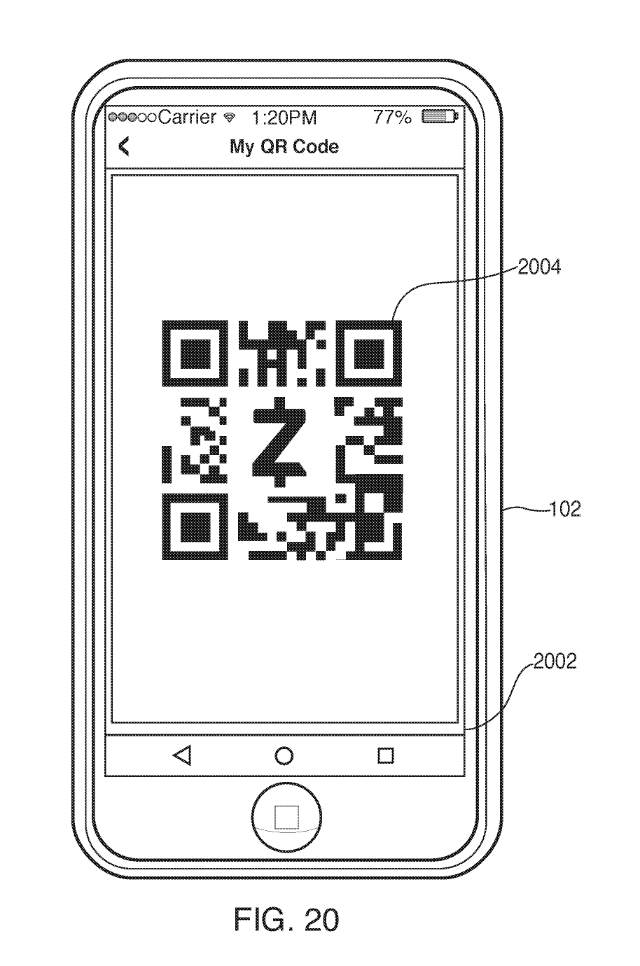

FIG. 19 shows application screen 1702 on mobile device 102. Cursor 116 may be positioned on show QR code button 1708. Selecting shown QR code button 1708 may direct the user to application screen 2002 on FIG. 20.

FIG. 20 shows application screen 2002 on mobile device 102. QR code 2004 may be displayed on application screen 2002. A second user may photograph QR code 2004 in order to transmit an electronic transmission to mobile device 102.

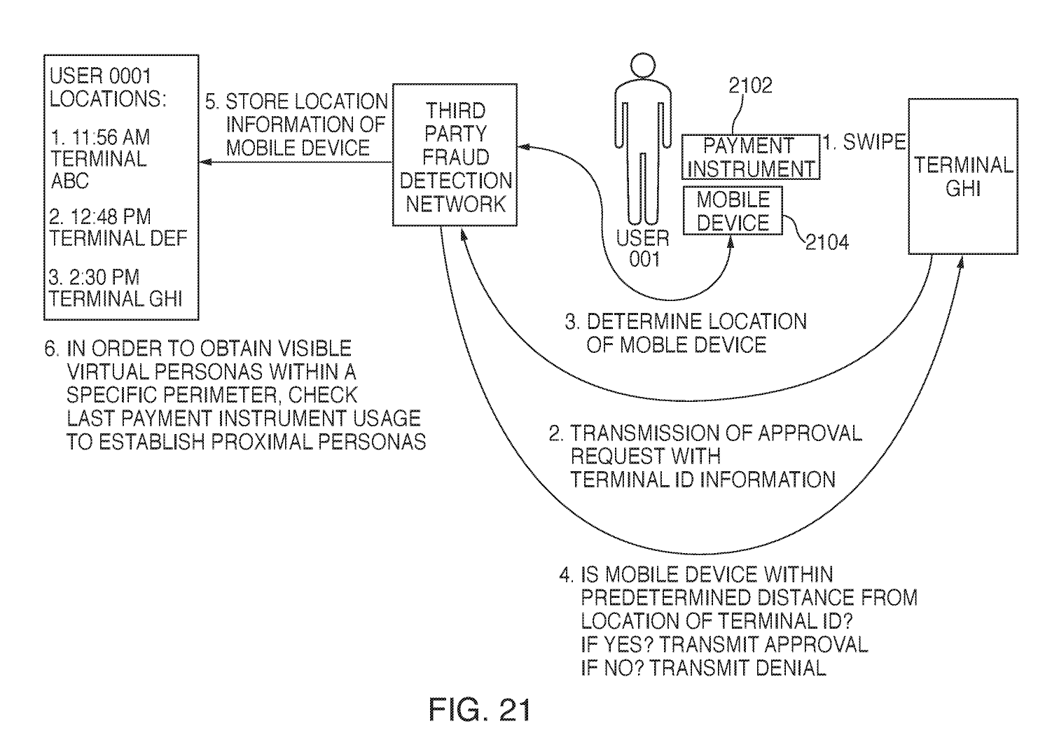

FIG. 21 shows an illustrative flow chart. The illustrative flow chart shows processes that may be implemented in connection with certain embodiments. User 0001 may carry payment instrument 2102 and mobile device 2104. User 0001 may swipe payment instrument 2102 at terminal GHI. In response to the swipe and pursuant to the fraud detection network protocols associated with third party fraud detection networks, terminal GHI may transmit an approval request to the third party fraud detection network. The approval request may include terminal ID information. The third party fraud detection network may determine, based on the present terminal ID location information and the location of mobile device 2104. Upon receipt of location information of mobile device 2104, third party fraud detection network may determine if mobile device is within a predetermined distance from the location of the terminal. If the mobile device is within the predetermined distance of the terminal, the third party fraud detection network may transmit an approval. If the mobile device is not within the predetermined distance, the third party fraud detection network may transmit a denial as a byproduct of its fraud detection protocol. The third party fraud detection network may store location information of user 0001 based on the retrieved location of mobile device 2104. In a process according to certain embodiments that leverage such a byproduct and in order to obtain visible virtual personas within a specific perimeter, the stored locations may be checked in order to establish proximal personas.

Thus, methods and apparatus for transmission, via a virtual persona, leveraging fraud detection networks have been provided. Persons skilled in the art will appreciate that the present invention can be practiced by other than the described embodiments, which are presented for purposes of illustration rather than of limitation.

What is claimed is:

1. A method for electronic transmission via a virtual persona, the method comprising:
receiving, at a first entity's mobile device, a request to transmit an electronic transmission;
in response to receiving the request, identifying a plurality of visible virtual personas associated with a plurality of other mobile devices, each of the virtual personas associated with a displayable image and/or characteristic set, wherein:
the identifying is based on information received from a third party fraud detection network, the information comprising location information associated with the plurality of other devices, said location information being currently exploited by the third party fraud detection network comprising a plurality of associations, wherein each association is between a payment instrument and one of the plurality of other mobile devices, said location information being identified each time the payment instrument operates as a payment method, said location information being identified using the GPS locators included in each mobile device;
the plurality of other mobile devices are located within a specific radial location-based perimeter constraint defined with respect to the first entity's mobile device;
displaying the visible virtual personas on the first entity's mobile device;
receiving a first selection, from the first entity, of a visible virtual persona, associated with the first entity, displayed on the first entity's mobile device;
receiving a second selection, from the first entity, of a visible virtual persona displayed on the first entity's device, the visible virtual persona associated with a second mobile device, included in the plurality of other mobile devices, said second device being located within the location-based perimeter constraint; and
transmitting the electronic transmission, via a transmission network, to:
a storage location associated with the second selected virtual persona; and
a storage location associated with the transmission network.

2. The method of claim 1, wherein the third party fraud detection network checks the geographic location of a mobile device each time a transaction attempt is made to a payment instrument associated with the mobile device.

3. The method of claim 1, wherein the use of the third party fraud detection network co-opts the bandwidth of the third party fraud detection network to identify the plurality of visible virtual personas.

4. The method of claim 1, wherein the identifying occurs upon completion of a predetermined interval of time.

5. The method of claim 1, wherein a virtual persona included in the plurality of visible virtual personas is made visible by the associated mobile device based on the location of the mobile device.

6. The method of claim 1, wherein a virtual persona included in the plurality of visible virtual personas is made visible by the associated mobile device based on a predetermined schedule.

7. An apparatus for electronic transmission via a virtual persona, the apparatus comprising:
a receiver, at a first entity's mobile device, configured to receive a request to transmit an electronic transmission;
a processor, at the first entity's mobile device, configured to identify a plurality of visible virtual personas associated with a plurality of other mobile devices, each of the virtual personas being associated with a displayable image, video clip and/or alphanumeric characteristic set, wherein:
the identification is based on information received from a third party fraud detection network, the information comprising location information associated with the plurality of other devices, said location information being currently exploited by the third party fraud detection network, said location information involving a plurality of associations, wherein each association is between a payment instrument and one of the plurality of other devices, said location information being retrieved or renewed each time the payment instrument operates as a payment device, said location information being identified using the GPS locators included in each mobile device; and
the plurality of other devices are located within a specific radial, location-based, perimeter constraint defined with respect to the first entity's mobile device;
a display, at the first entity's mobile device, configured to display the visible virtual personas on the first entity's mobile device;
the receiver further configured to:
receive a selection, from the first entity, of a visible virtual persona displayed on the first entity's device, the visible virtual persona associated with a second mobile device, included in the plurality of other mobile devices, said second device being located within the location-based perimeter constraint;
a transmitter configured to transmit the electronic transmission, via a transmission network, to:
a storage location associated with the second selected virtual persona; and
a storage location associated with the transmission network.

8. The apparatus of claim 7, wherein the third party fraud detection network queries the geographic location of a mobile device each time a transaction attempt is made to a payment instrument associated with the mobile device.

9. The apparatus of claim 7, wherein the use of the third party fraud detection network co-opts the bandwidth of the third party fraud detection network to identify the plurality of visible virtual personas.

10. The apparatus of claim 7, wherein the identification occurs upon completion of a predetermined interval of time.

11. The apparatus of claim 7, wherein a virtual persona included in the plurality of visible virtual personas is made visible by the associated mobile device based, at least in part, on the location of the associated mobile device.

12. The apparatus of claim 7, wherein a virtual persona included in the plurality of visible virtual personas is made visible by the associated mobile device based, at least in part, on a predetermined schedule.

13. A method for electronic transmission via a virtual persona, the method comprising:
receiving, at a first entity's mobile device, a request to transmit an electronic transmission;
photographing, at the first entity's mobile device, a quick response (“QR”) code, the QR code being associated with a virtual persona, said virtual persona being associated with a second entity's mobile device, said virtual persona being associated with a displayable image and/or characteristic set;
identifying the virtual persona associated with the QR code by:
transmitting the QR code to a website; and
receiving the virtual persona in response to the transmitting the QR code;
displaying the virtual persona on the first entity's mobile device;
receiving a first selection, from the first entity, of a virtual persona associated with the first entity;
receiving a second selection, from the first entity, of the identified virtual persona;
transmitting the electronic transmission, via the transmission network, to:
a storage location associated with the second entity's mobile device; and
a storage location associated with the transmission network.

14. The method of claim 13, wherein the virtual persona associated with the first entity is selected from a plurality of virtual personas associated with the first entity.

15. The method of claim 13, wherein the virtual persona associated with the first entity includes a displayable image associated with the first entity.

16. The method of claim 13, wherein the virtual persona associated with the first entity includes an alphanumeric character set associated with the first entity.

17. The method of claim 13, wherein the second entity receives an alert relating to the electronic transmission when the transmission is received at the storage location associated with the second entity's mobile device.
